(19) United States
(12) Patent Application Publication
(10) Pub. No.: US 2011/0279263 A1
(43) Pub. Date: Nov. 17, 2011

(54) Event Detection

(76) Inventors: Ryan Scott Rodkey, Sugar Land, TX (US); John Frank Rodkey, JR., Missouri City, TX (US); David Lynn Hickey, Rosharon, TX (US); Darren Lynn Ross, Sugarland, TX (US)

(21) Appl. No.: 12/779,587

(22) Filed: May 13, 2010

(51) Int. Cl. G08B 21/00

(52) U.S. Cl. 340/539.13

(57) ABSTRACT

A location aware mobile device may include an accelerometer or similar motion sensing component that can measure changes in speed or direction. An application executing in the mobile device can determine whether particular motion changes are indicative of the mobile device being involved in a crash event. If the motion parameters indicate that a crash event has occurred, the mobile device can communicate a crash event notification to a server, which can alert an emergency response unit about the crash, including the crash location, without the need for human intervention. Verification of the crash event may be performed at the server in a variety of ways, including the simultaneous receipt of crash event notifications from multiple co-located devices.

### FIELD OF THE INVENTION

This disclosure relates to mobile communications systems and applications that can execute in mobile communications environments, in particular with mobile devices. More specifically, this disclosure relates to applications that can be used for detecting events such as vehicular crashes.

### BACKGROUND OF THE INVENTION

When events such as accidents occur involving transports (such as vehicles, motorcycles, buses, planes, boats, etc.), alerting emergency services authorities and the dispatching of an emergency response unit such as ambulance, police or fire departments typically requires a person to call the emergency number, e.g. 911 to report the crash event. This can cause delays in the dispatch of the emergency response unit due to the time taken for a crash victim or witness to call the emergency number and also due to the time taken for the victim or witness to accurately report the location of the incident.

What is required is an improved system, method and computer readable medium for detection of events such as crashes, airbag deployment, collision, vehicle impact, spinning motion, loss of control, rapid loss of tire pressure, rapid fluid loss, detection of fire, flooding, sudden un-leveling of the vehicle, maintaining of an unleveled position, rapid increase or decrease of altitude, excessive on vehicle, carbon monoxide detection, radon detection, detection of sudden or extreme temperature increase or decrease, sudden change in direction, and Please list additional events that can be detected.

### SUMMARY OF THE INVENTION

In one aspect of the disclosure, there is provided a method for indicating a crash event comprising detecting a crash event in a mobile device and communicating an indication of the crash event to a server.

In one aspect of the disclosure, there is provided a server configured to receive motion data from at least one mobile device, determine that the motion data indicates a crash event, and provide a notification of the crash event to at least one emergency response unit.

In one aspect of the disclosure, there is provided a computer-readable medium comprising computer-executable instructions for execution by a processor of a mobile device, that, when executed, cause the processor to determine at least one motion parameter of the mobile device, determine if the at least one motion parameter meets a crash indicating threshold; and communicate at least one of the at least one motion parameter or a crash event notification to a server.

### BRIEF DESCRIPTION OF THE DRAWINGS

Reference will now be made, by way of example only, to specific embodiments and to the accompanying drawings in which:

FIG. 1 shows a system for detecting crash events;

FIG. 2 shows a process for indicating crash events;

FIG. 3 shows a process for determining if motion parameters of a mobile device indicate a crash event;

FIG. 4 shows a process for verifying a crash event;

FIG. 5 shows a processor and memory of a mobile device; and

FIG. 6 shows an instruction set executable on the processor of the mobile device of FIG. 5.

### DETAILED DESCRIPTION OF THE INVENTION

The system 10 includes a server 12 that provides mobile telecommunication services to one or more mobile devices via one or more base stations 14 to define a telecommunications network.

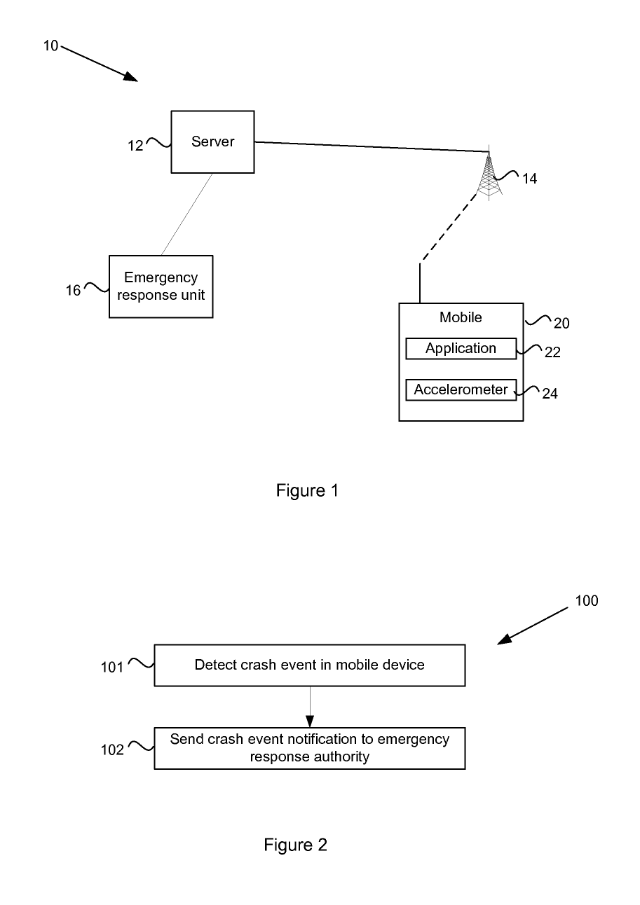

In the flowchart 100 of FIG. 2, there is shown a method for detection of a crash event using the system 10. A device 20 detects a crash event at step 101 and communicates a crash event notification to a server, such as an emergency response server, at step 102. These embodiments assume that the crash event is first detected in the mobile device and then notified to the server only when the motion data indicates a crash event has occurred. This method would reduce the necessary bandwidth compared to reporting all motion data to the server for the server to process.

With reference to FIG. 1, the mobile device 20 may be configured with an internal tracking system, e.g. based on GPS or similar satellite or base station communications, that provides the mobile device with location aware capabilities. Such capabilities may be used for navigation, location based services and the like. The internal tracking system may include an accelerometer 24, gyroscope, or similar motion sensing component for measuring motion parameters such as speed and direction changes of the mobile device 20.

In one embodiment, the mobile device 20 may be a personal device such as a mobile phone, hand-held web browser, laptop computer, music player, personal navigation device, etc that may be configured for telecommunications services through the server 12. In an alternative embodiment, the mobile device may be a component of a motor vehicle, such as a device configured to interface with a navigation module, or a navigation module configured to provide wireless communications to the server 12, with or without additional telecommunications services such as voice and text.

The mobile device 20 may execute an application 22 that interacts with the accelerometer 24 or other motion sensing aspects of the mobile device 20 and that may be used to detect crash events. The application 22 is configured to detect when the accelerometer readings or motion readings exceed the threshold levels that indicate a crash event has occurred. As soon as the application detects the crash event, the application generates a crash event notification and communicates the crash event notification to the server 12.

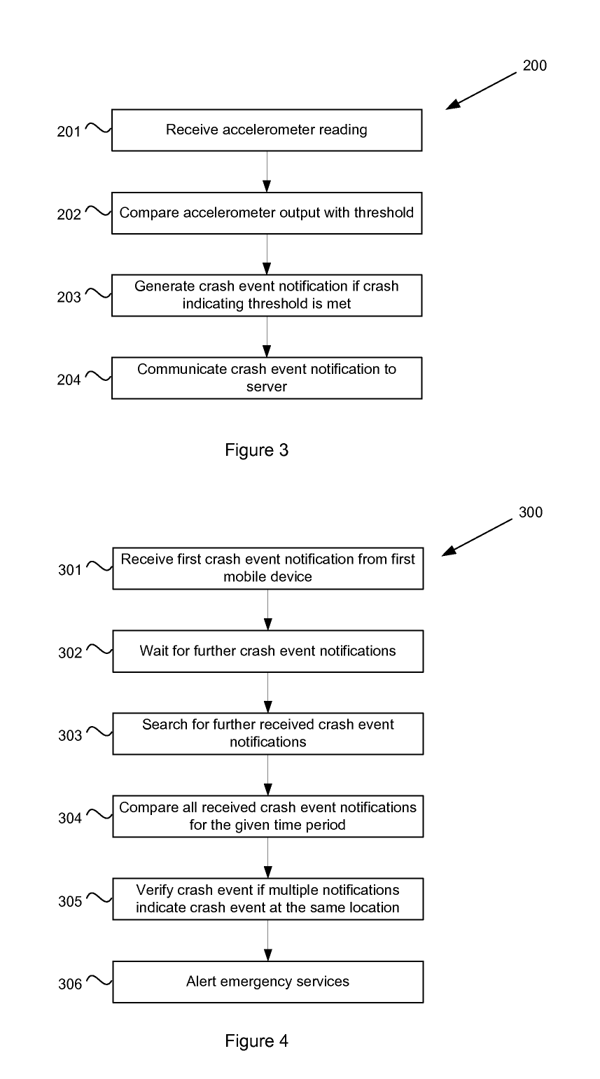

An example process for detecting crash events is illustrated in the flowchart 200 of FIG. 3. At step 201, the application 22 receives accelerometer readings from the accelerometer 24. The application 22 compares the accelerometer output to a crash-indicating threshold (step 202). If the accelerometer output is above the crash indicating threshold, then the application proceeds to generate a crash event notification (step 203) which is sent to the server 12 (step 204). In one embodiment, a crash indicating threshold is set to distinguish accelerometer readings of crash events from other less severe impact events such as dropping of the mobile device causing a sudden impact with the ground. The accelerometer thresholds may be set as a duration of a negative acceleration, with crash indicating decelerations typically being longer than sudden impact decelerations when a device is dropped, shaken or hit. Alternatively or in addition, the accelerometer measurement thresholds may be set as a total calculated deceleration, with severe crash impact decelerations that would require an emergency response typically being greater than decelerations caused when a device was dropped from a typically hand-held height, e.g. approximately 1 meter. This disclosure would benefit greatly if a very specific example could be provided that would give guidance on the crash indicating threshold. If possible, please provide an example stating accelerometer make and model, output reading for a non-crash impact (e.g. dropping or shaking), an output reading for a crash-indicating impact and a suggested threshold.

Other methods for determining crash events may use successive location measurements to determine changes in speed and/or direction. For example, a crash event may be indicated by a device being above a certain threshold speed and then suddenly below it based on the accelerometer and/or the gyroscope in the device. These readings can be compared to the GPS readings of the device which include distance and speed measurements (and further compared to Received Signal Strength Indication (RSSI) readings). If all of these readings coincide, then the hypotheses that a crash event has occurred will increase.

A crash event notification to the server 12 may include such information as the most recently recorded location, i.e. if the mobile device is location aware, as well as crash parameters such as severity of impact, direction of travel, time of crash etc. If the mobile device is able to identify a vehicle that might be involved in the crash then the crash notification may include the vehicle identity. For example, the mobile device 20 may be a navigation unit registered to a particular vehicle, or the mobile device may be a user's personal mobile device which could at least provide a suggestion to emergency services of the vehicle involved in a crash event. Alternatively, a crash event notification may more simply provide an indication that a particular threshold has been met.

At the server end, the server 12 receives the crash notification and alerts the appropriate emergency response system 16. The server may be a server of an emergency services authority so that communications are sent directly from the mobile device to the emergency services. An emergency services authority server may be configured to select an emergency response unit based on a location of the crash event, as determined from the crash event notification or by the server 12, so that the correct response unit is notified as quickly as possible. In one embodiment, the server 12 may alert one or more of an ambulance, police, fire department or similar rescue services unit. In one embodiment, the server 12 may alert one or more accident services such as a tow truck service.

In one embodiment, the server 12 may be configured to verify the crash event. Verification may be performed in one or more of a variety of ways. A first verification example is shown in the flowchart 300 of FIG. 4. At step 301, the server receives a first crash event notification from a first mobile device. The server then waits for a predetermined time period (step 302), e.g. 30 seconds, and then searches to see if any other crash event notifications have been received (step 303). If the server 12 has received any further crash event notifications, e.g. from a second mobile device, then all of the received crash event notifications for the given time period are compared (step 304). If the crash event notifications show that two or more notifications have occurred at the same location then the crash event is verified (step 305) and the appropriate emergency response unit is alerted (step 306).

The use of verifications may allow the crash indicating thresholds to be lowered. For example, a mobile device may be configured with a lower crash-indicating threshold that could also indicate other types of non-crash impacts. The mobile device will thus send notifications to the server 12 under a greater number of circumstances. In order to prevent undue emergency responses, the server 12 will verify whether the potential crash events are actual crash events.

In one embodiment, verification may be based on the speed of a mobile device immediately prior to a detected impact. Either the application 22 or the server 12 may be configured to determine that the mobile device was moving at a vehicle-related speed immediately prior to the crash event, e.g. using GPS readings, but has since stopped. If the mobile device was stationary or moving slowly (e.g. at pedestrian speed), then the device may be determined to be less likely to have been involved in a vehicle related incident. Similarly, either the application 22 or the server 12 may be configured to determine the location of the mobile device 20 immediately prior to a detected impact. If the location does not correlate to a roadway, railway or other transport corridor, then a vehicle related incident is unlikely to have occurred. In other embodiments, the application or the server 12 may be configured to use both speed and location information to verify accelerometer readings in order to determine whether a detected impact correlates to a crash event. Using both speed and location data may assist to verify particular types of crash events, such as pedestrian incidents, where a pedestrian may have been moving at a non-vehicle speed but on a roadway.

In one embodiment, verification of a non-crash impact may be performed manually. Upon receipt by the server 12 of an impact notification, the server 12 may send a response query to the mobile device 20 that asks the user to verify whether a crash event has occurred. If either the user verifies that the impact was a non-crash event or does not provide a response, or if the server is unable to communicate with the mobile device 20, then the server 12 may consider that a crash event has been verified and may then proceed to alert the appropriate emergency response unit.

The server 12 may also compare readings from all devices in a particular area. For example, there could be hundreds of devices in transports on a highway. Suddenly, six devices show readings above (or below) a threshold while all other devices in that area show normal readings. It is then ascertained that these devices are located in two transports. The server 12 may thus determine that those two transports were involved in a crash. The server could also determine the severity of the crash based on the deltas in the thresholds and send appropriate emergency personnel such as police and fire for a typical crash, ambulance for a more severe crash, helicopter for the most serious crashes, etc.

The ability to compare data from different devices within the same transport (car, bus, train, motorcycle, etc.) may also be used to confirm a crash event and provide additional details about the event. For example, an accelerometer reading may suddenly change in one of two devices in a transport. The server may thus determine that a user has dropped their device. However, a changed reading of two or more devices in a transport may indicate a crash has occurred if both devices are above a certain threshold (indicating, for example, an immediate increase in speed) or below a certain threshold (indicating, for example, an immediate decrease in speed) or the devices are first above the threshold and then suddenly below it or vice versa. If one of these devices is higher above the threshold than the other, then a direction of the crash can be ascertained. For example, if a driver's device shows a first reading above a threshold and a passenger's device sitting adjacent to the driver has a second reading above the threshold and the drivers' device threshold, the server 12 can determine that an accident occurred on the passenger's side of the transport. The server may also determine that the transport is a vehicle because of the distance between the two devices (based on GPS readings or device-to-device readings) and/or based on the number of devices in the transport. For example, more than seven devices would indicate the transport is a bus or train. The server 12 may also determine the type of transport based on the location of the transport. For example, a transport operating on or near a rail would indicate it is a train, a transport operating in a similar loop over and over again would indicate it is a bus, etc.

In motor vehicle embodiment, the mobile device 20 might be provided in a vehicle in a manner that increases its chances of remaining operative after a crash event and may include additional structural elements that enable it to survive a crash impact.

In one embodiment, the mobile device may be configured to detect a crash event and not only alert the emergency response server 12 of the crash event, but also periodically transmit a beacon-style signal that can guide an emergency response unit to the scene of the crash event.

An advantage of the present embodiments is the ability to alert an emergency response authority without human intervention. This is particular advantageous in remote areas where crashes may occur without witnesses available to alert the emergency services.

While the crash events have been described with particular reference to vehicle and train related crash events, the term “crash event” is intended to encompass all manner or potential impacts. Other examples of impacts that might be detected by the above described methods include bomb blasts and terrorist related incidents.

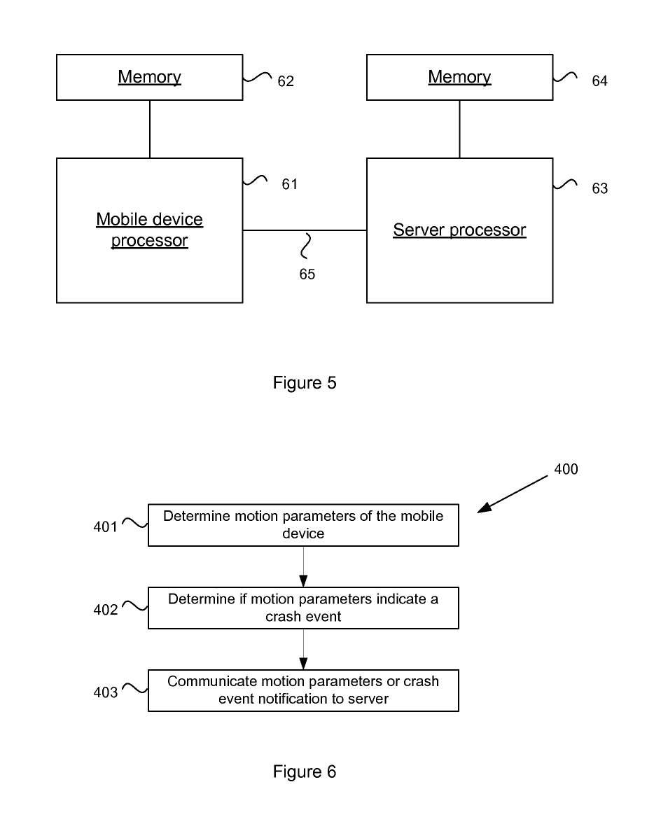

The components of the system 10 may be embodied in hardware, software, firmware or a combination of hardware, software and/or firmware. In a hardware embodiment, the application 22 may be executed on a processor 61 of the mobile device 20 that is operatively associated with a memory 62 as shown in FIG. 5. The memory 62 may store instructions that are executable on the processor 61. In addition, the memory 62 may store additional information such as the crash indicating thresholds and the like. The processor 61 may communicate with a processor 63 of the server through wireless communications 65. The server processor may also be operatively associated with a memory 64. An instruction set 400 that may be executed on the processor 61 is depicted in the flowchart of FIG. 6. Specifically, when executed, the instruction set 400 allows the processor 61 to determine motion parameters of the mobile device (step 401), such as from an accelerometer. The processor 61 may then determine if the motion parameters meet a crash indicating threshold (step 402) and if so, communicate at least the motion parameters or a crash event notification to the server (step 403).

While the server 12 is shown as a single server that provides standard wireless communications and receives crash notifications, these functions may be separated into multiple servers. That is, the mobile device 20 may provide traditional communications services such as text and voice through one server, while the mobile application 22 of the device 20 may be configured with server contact details that enable the device 20 to establish communications with an emergency response server whenever crash events are detected.

Although embodiments of the present invention have been illustrated in the accompanying drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. A method for indicating a crash event comprising:
detecting a crash event in a mobile device; and
communicating an indication of the crash event to a server.

2. The method according to claim 1 wherein detecting a crash event comprises measuring at least one motion parameter of the mobile device and comparing the at least one motion parameter to a threshold.

3. The method according to claim 1 wherein communicating an indication of the crash event comprises communicating a location of the mobile device.

4. The method according to claim 1 comprising alerting an emergency response unit of the crash event from the server.

5. The method according to claim 1 comprising verifying the crash event in the server.

6. The method according to claim 5 wherein verifying the crash event comprises:
receiving a plurality of crash event indications from a plurality of mobile devices at the server; and
correlating at least one of time data or location data of the plurality of crash event indications.

7. The method according to claim 5 wherein verifying the crash event comprises comparing motion data of a first mobile device with motion data of a second mobile device.

8. The method according to claim 5 wherein verifying the crash event comprises providing a query from the server to the mobile device.

9. The method according to claim 7 wherein verification of a crash event is dependent on a response to the query from the mobile device or a lack of a response to the query from the mobile device.

10. A server configured to:
receive motion data from at least one mobile device;
determine that the motion data indicates a crash event; and
provide a notification of the crash event to at least one emergency response unit.

11. The server according to claim 10 wherein the motion data comprises a crash event notification that indicates that the motion data has met a crash event threshold.

12. The server according to claim 11 configured to:
receive a plurality of crash notifications from a plurality of mobile devices; and
correlate at least one of time data and location data of the plurality of crash notifications to verify the crash event.

13. The server according to claim 11 configured to provide a verification query to the mobile device in response to receiving the crash event notification.

14. The server according to claim 10 configured to:
receive motion data from a plurality of mobile devices; and
compare motion data of the plurality mobile devices to determine a crash event.

15. The server according to claim 14 wherein the motion data of a mobile device comprises a location of the mobile device and at least one impact indicating parameter of the mobile device, and wherein the server is configured to verify that a crash event has occurred if motion data of a plurality of mobile devices indicates a common location and at least one common impact indicating parameter.

16. The server according to claim 14 wherein the motion data of a mobile device comprises a location of the mobile device and at least one impact indicating parameter of the mobile device, and wherein the server is configured to determine that a crash event has not occurred if motion data of a plurality of mobile devices at a common location indicates that only one of the plurality of mobile devices has undergone an impact.

17. A computer-readable medium comprising computer-executable instructions for execution by a processor of a mobile device, that, when executed, cause the processor to:
determine at least one motion parameter of the mobile device;
determine if the at least one motion parameter meets a crash indicating threshold; and
communicate at least one of the at least one motion parameter or a crash event notification to a server.

18. The computer-readable medium according to claim 17 comprising instructions that, when executed by the processor, cause the processor to determine that a location of the mobile device correlates to a roadway and that an acceleration of the mobile device correlates to a motor vehicle accident event.

19. The computer-readable medium according to claim 17 comprising instructions that, when executed by the processor, cause the processor to indicate the location of the mobile device to the server.

20. The computer-readable medium according to claim 17 comprising instructions that, when executed by the processor, cause the processor to periodically communicate a location indicating signal to the server to notify the server of the location of a crash event.

21. The method according to claim 1 wherein the mobile device will initiate a notification using Bluetooth

22. The method according to claim 21 wherein the Bluetooth notification can be transmitted/broadcast through a separate audio device

23. The method according to claim 22 wherein the separate audio device can be automobile speakers.

24. The method according to claim 1 wherein the mobile device will initiate a notification upon the deployment of an airbag.
